(19) United States
(12) Patent Application Publication
(10) Pub. No.: US 2025/0003754 A1
(43) Pub. Date: Jan. 2, 2025

(54) ROUTE PROCESSING METHOD, TERMINAL DEVICE, AND STORAGE MEDIUM

(71) Applicant: GUANGDONG COROS SPORTS TECHNOLOGY CO., LTD, Dongguan (CN)

(72) Inventors: Haotian NIU, Dongguan (CN); Yu TANG, Dongguan (CN); Jingguang LIU, Dongguan (CN); Kai CHEN, Dongguan (CN)

(21) Appl. No.: 18/758,339

(22) Filed: Jun. 28, 2024

(30) Foreign Application Priority Data
Jun. 28, 2023 (CN) 202310783655.X

(51) Int. Cl. G01C 21/20; G01C 21/00; G06T 17/00

(52) U.S. Cl. CPC G01C 21/20; G01C 21/3826; G06T 17/00

(57) ABSTRACT

A route processing method includes obtaining a three-dimensional climbing route of a user that include one or more first three-dimensional positions of the user during climbing, determining whether a preset marking condition is satisfied, determining a second three-dimensional position of a target point according to the one or more first three-dimensional positions in response to the marking condition being satisfied, obtaining map information including a preset three-dimensional model, controlling a display component to display the map information, and controlling the display component to superimpose and display the three-dimensional climbing route and the target point on the three-dimensional model according to the one or more first three-dimensional positions and the second three-dimensional position.

### CROSS-REFERENCE TO RELATED APPLICATION

This application claims priority to Chinese Patent Application No. 202310783655.X, filed on Jun. 28, 2023, the entire content of which is incorporated herein by reference.

### TECHNICAL FIELD

The present disclosure generally relates to the field of electronic map technologies and, more particularly, to a route processing method, a terminal device, and a storage medium.

### BACKGROUND

At present, climbing routes of users during rock climbing or mountain climbing are mainly drawn in a form of planar maps for other people to view and refer to. However, since actual conditions of rock walls or mountains are usually complicated, the form of planar maps cannot accurately reflect real information of the climbing routes, making the reference effect of the climbing routes limited.

### SUMMARY

In accordance with the present disclosure, there is provided a route processing method including obtaining a three-dimensional climbing route of a user that include one or more first three-dimensional positions of the user during climbing, determining whether a preset marking condition is satisfied, determining a second three-dimensional position of a target point according to the one or more first three-dimensional positions in response to the marking condition being satisfied, obtaining map information including a preset three-dimensional model, controlling a display component to display the map information, and controlling the display component to superimpose and display the three-dimensional climbing route and the target point on the three-dimensional model according to the one or more first three-dimensional positions and the second three-dimensional position.

Also in accordance with the present disclosure, there is provided a terminal device including at least one memory storing at least one computer program, and at least one processor configured to execute the at least one computer program to obtain a three-dimensional climbing route of a user that includes one or more first three-dimensional positions of the user during climbing, determine whether a preset marking condition is satisfied, determine a second three-dimensional position of a target point according to the one or more first three-dimensional positions in response to the marking condition being satisfied, obtain map information including a preset three-dimensional model, control a display component to display the map information, and control the display component to superimpose and display the three-dimensional climbing route and the target point on the three-dimensional model according to the one or more first three-dimensional positions and the second three-dimensional position.

Also in accordance with the present disclosure, there is provided a non-transitory computer readable storage medium storing at least one computer program that, when executed by at least one processor, causes the at least one processor to obtain a three-dimensional climbing route of a user that includes one or more first three-dimensional positions of the user during climbing, determine whether a preset marking condition is satisfied, determine a second three-dimensional position of a target point according to the one or more first three-dimensional positions in response to the marking condition being satisfied, obtain map information including a preset three-dimensional model, control a display component to display the map information, and control the display component to superimpose and display the three-dimensional climbing route and the target point on the three-dimensional model according to the one or more first three-dimensional positions and the second three-dimensional position.

### BRIEF DESCRIPTION OF THE DRAWINGS

FIG. 1 is a flow chart of a route processing method consistent with the present disclosure.

FIG. 2 is a flow chart of another route processing method consistent with the present disclosure.

FIG. 3 is a flow chart of another route processing method consistent with the present disclosure.

FIG. 4 is a flow chart of another route processing method consistent with the present disclosure.

FIG. 5 is a flow chart of another route processing method consistent with the present disclosure.

FIG. 6 is a flow chart of another route processing method consistent with the present disclosure.

FIG. 7 is a flow chart of another route processing method consistent with the present disclosure.

FIG. 8 is a flow chart of another route processing method consistent with the present disclosure.

FIG. 9 is a schematic structural diagram of a terminal device consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure and do not limit the scope of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. The present disclosure may also be implemented in other embodiments without these specific details. In other cases, detailed descriptions of well-known systems, devices, circuits, and methods are omitted so as not to obscure the description of the present disclosure with unnecessary details.

When used in the specification and the claims in the present disclosure, the term “including” indicates the presence of the described features, wholes, steps, operations, elements and/or components, but does not exclude the presence or addition of one or more other features, wholes, steps, operations, elements, components and/or their collections.

It should also be understood that the term “and/or” used in the specification and the claims in the present disclosure refers to any combination of one or more of the items listed in association and all possible combinations, and includes these combinations.

As used in the specification and the claims in the present disclosure, the term “if” can be interpreted as “when . . . ” or “once” or “in response to determination of” or “in response to detection of” according to the context. Similarly, the phrase “if it is determined” or “if [the described condition or event] is detected” can be interpreted as meaning “once it is determined” or “in response to determination of” or “once [the described condition or event] is detected” or “in response to detection of [the described condition or event]” according to the context.

In addition, in the specification and the claims in the present disclosure, the terms “first,” “second,” “third,” etc. are only used to distinguish the description, and cannot be understood as indicating or implying relative importance.

References to “one embodiment” or “some embodiments” etc. described in the specification of the present disclosure mean that one or more embodiments of the present disclosure include specific features, structures or characteristics described in conjunction with the embodiments. Therefore, the statements “in one embodiment,” “in some embodiments,” “in some other embodiments,” etc., that appear in different places in this specification do not necessarily refer to the same embodiment, but mean “one or more but not all embodiments,” unless otherwise specifically emphasized in other ways. The terms “including,” “comprising,” “having” and their variations all mean “including but not limited to,” unless otherwise specifically emphasized in other ways. “Multiple” or “a plurality of” means “two or more.”

At present, climbing routes of users during rock climbing or mountain climbing are mainly drawn in a form of planar maps for other people to view and refer to. However, since actual conditions of rock walls or mountains are usually complicated, the form of planar maps cannot accurately reflect real information of the climbing routes, making the reference effect of the climbing routes limited.

The present disclosure provides a route processing method to at least partially solve the above problem. In the route processing method provided by the present disclosure, a three-dimensional climbing route of a user may be obtained. The three-dimensional climbing route may include first three-dimensional positions of the user during the climbing process. When a marking condition is satisfied, a second three-dimensional position of a target point may be determined according to the first three-dimensional positions, and a display component may be controlled to superimpose and display the three-dimensional climbing route and the target point on a three-dimensional model according to the first three-dimensional positions and the second three-dimensional position. Therefore, the climbing route of the user during the climbing process may be able to be drawn and saved in the form of a three-dimensional map, and the combination of the three-dimensional climbing route and the three-dimensional model may more accurately reflect the real information of the climbing route, thereby enhancing the reference effect of the climbing route for other people.

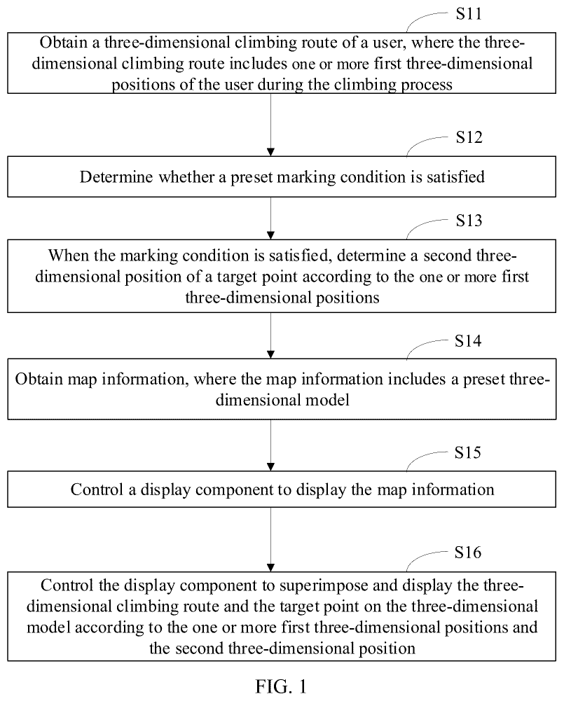

In one embodiment shown in FIG. 1, the route processing method includes S11 to S16.

At S11, a three-dimensional climbing route of a user is obtained. The three-dimensional climbing route may include one or more first three-dimensional positions of the user during the climbing process.

In one embodiment, climbing may include rock climbing or mountain climbing, etc. The three-dimensional climbing route of the user may be obtained through a wearable device carried by the user, and the wearable device may include a smart watch, etc. The first three-dimensional positions may include coordinates and altitudes of the user. By integrating a barometer or a GPS module in the wearable device, high-precision acquisition of the altitudes and coordinates of the user may be achieved. When designing the hardware of the wearable device, a suitable barometer or GPS module, such as a BMP280 barometer or a NEO-6M GPS module, may be selected according to the design requirements and budget, and the barometer or GPS module may be connected to the main board of the wearable device through a circuit board.

In one embodiment, according to the specific models of the barometer or the GPS module, corresponding drivers may be written such that the main board of the wearable device is able to read the data of the barometer or the GPS module. After the development of the wearable device hardware and software is completed, testing and optimization may be carried out to ensure the accuracy and stability of the acquisition of the altitudes and coordinates of the user. The wearable device may read the current air pressure or location information through the barometer or GPS module, calculate the user's coordinates or altitude, and store these data in the memory of the wearable device. A user interface of the wearable device may also be designed according to the design requirements, such that the user is able to easily view information such as coordinates and altitude.

In one embodiment shown in FIG. 2, obtaining the three-dimensional climbing route of the user includes:
S21: obtaining the one or more first three-dimensional positions; and
S22: generating the three-dimensional climbing route according to the one or more first three-dimensional positions.

In one embodiment, obtaining the first three-dimensional positions may include that the wearable device collects data in real time during the user's climbing process to obtain the several first three-dimensional positions of the user during the climbing process. Generating the three-dimensional climbing route based on the first three-dimensional positions may include that, after the wearable device obtains the several first three-dimensional positions of the user during the climbing process, these first three-dimensional positions are automatically connected into a line to generate the user's three-dimensional climbing route.

Refer again to FIG. 1, at S12, whether a preset marking condition is satisfied is determined.

In one embodiment, during the climbing process, the user may want to mark some important locations for reference by other people, such as marking pitons during rock climbing, marking road signs during mountain climbing, etc. Therefore, the wearable device may implement a route marking function through an algorithm, such as marking through location information collected by GPS, or using other sensor data combined with machine learning algorithms to achieve automatic marking. Determining whether the preset marking condition is satisfied may include that the wearable device determines whether the preset marking condition is satisfied. The preset marking condition may include that the user has performed a marking operation through the wearable device, or the user has not moved for more than a preset time.

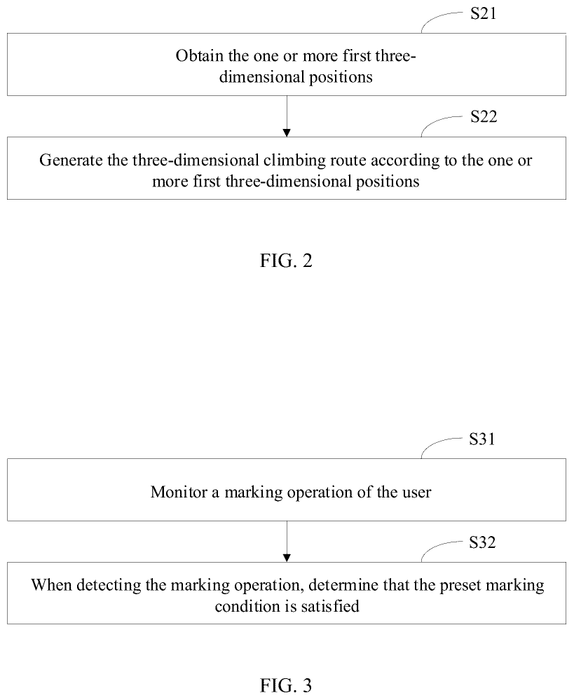

In one embodiment shown in FIG. 3, determining whether the preset marking condition is satisfied includes:
S31: monitoring a marking operation by the user, i.e., determining whether the user's marking operation is received; and
S32: when the marking operation is detected, i.e., when the marking operation is received, determining that the preset marking condition is satisfied.

In one embodiment, determining whether the user's marking operation is received may include that the wearable device determines whether the marking operation of the user is received, and the marking operation may include key marking or voice-controlled marking, etc. Determining that the preset marking condition is satisfied when the marking operation is received may include that the wearable device determines that the preset marking condition is satisfied when the marking operation of the user is received.

Refer again to FIG. 1, at S13, when the marking condition is satisfied, a second three-dimensional position of a target point is determined according to the one or more first three-dimensional positions.

In one embodiment, when the marking condition is satisfied, determining the second three-dimensional position of the target point according to the first three-dimensional positions may include that, when the marking condition is satisfied, the wearable device determines the second three-dimensional position of the target point according to the first three-dimensional positions of the user. The target point may be the point that the user wants to mark during the climbing process. The second three-dimensional position may include the coordinates and altitude of the target point.

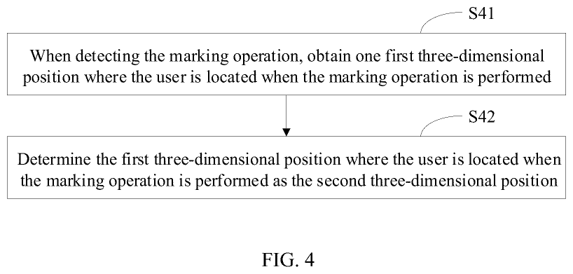

In one embodiment shown in FIG. 4, when the marking condition is satisfied, determining the second three-dimensional position of the target point according to the one or more first three-dimensional positions includes:
S41: when detecting the marking operation, i.e., when receiving the marking operation, obtaining one first three-dimensional position of the user when the user performs the marking operation; and
S42: determining the first three-dimensional position of the user when the user performs the marking operation as the second three-dimensional position. That is, the first three-dimensional position that the user is at when performing the marking operation is determined as the second three-dimensional position.

In one embodiment, obtaining the first three-dimensional position where the user performs the marking operation when receiving the marking operation may include that the wearable device acquires the coordinates and altitude where the user performs the marking operation when receiving the marking operation such as key marking or voice-controlled marking by the user. Determining the first three-dimensional position where the user performs the marking operation as the second three-dimensional position may include that the wearable device determines the coordinates and altitude where the user performs the marking operation as the second three-dimensional position. After the second three-dimensional position of the target point is determined, the data may be stored in the memory of the wearable device, or transmitted to a mobile phone APP via Bluetooth for storage for subsequent analysis.

In one embodiment, the route processing method may further include: determining whether the user moves according to the first three-dimensional positions. Determining whether the preset marking condition is satisfied may further include: when the user movement is not detected within a preset time period, determining that the preset marking condition is satisfied. Determining the second three-dimensional position of the target point according to the first three-dimensional position when the marking condition is satisfied may also include: determining the first three-dimensional position where the user is located when the user movement is not detected as the second three-dimensional position of the target point.

In one embodiment, the wearable device may collect user movement data through GPS, gyroscope, accelerometer, etc., and determine whether the user has moved based on the user's first three-dimensional positions. The user may encounter some special situations during the climbing process, causing the user to stop moving for a preset period of time. Therefore, the wearable device may also determine that the preset marking condition is satisfied when the user movement is not detected within the preset period of time, and determine the first three-dimensional position of the user when the user movement is not detected as the second three-dimensional position of the target point, such that the position of the user when encountering the special situation may be marked as the target point for reference by other people.

Refer again to FIG. 1, at S14, map information including a preset three-dimensional model is obtained.

At S15, a display component is controlled to display the map information.

At S16, the display component is controlled to superimpose and display the three-dimensional climbing route and the target point on the three-dimensional model according to the one or more first three-dimensional positions and the second three-dimensional position.

In one embodiment, the above map information may be pre-stored in the user's mobile phone APP, including map information of any location, and the map information may also include a three-dimensional model of any rock wall or mountain that the user may climb. The above display component may include a mobile phone, etc. Controlling the display component to display the map information, and controlling the display component to superimpose and display the three-dimensional climbing route and target point on the three-dimensional model according to the first three-dimensional positions and the second three-dimensional position, may include that, the wearable device is connected to the display component via Bluetooth, to transmit the first three-dimensional positions of the three-dimensional climbing route and the second three-dimensional position of the target point to the display component, such that the three-dimensional climbing route and the target point are superimposed and displayed on the three-dimensional model corresponding to the user's climbing process. When the user uses the display component to open the map information, the three-dimensional climbing route and target point may be superimposed and displayed on the three-dimensional model automatically.

In the route processing method provided by the present disclosure, the user's three-dimensional climbing route may be obtained and the three-dimensional climbing route may include the user's first three-dimensional positions during the climbing process. The second three-dimensional position of the target point may be determined according to the first three-dimensional positions when the marking condition is satisfied, and the display component may be controlled to superimpose and display the three-dimensional climbing route and the target point on the three-dimensional model according to the first three-dimensional positions and the second three-dimensional position. Therefore, the user's climbing route during the climbing process may be drawn and saved in the form of a three-dimensional map. Further, the combination of the three-dimensional climbing route and the three-dimensional model may be able to satisfy the user's need to view the climbing route through the three-dimensional map, the real information of the climbing route may be reflected more accurately, thereby enhancing the reference effect of the climbing route for other people.

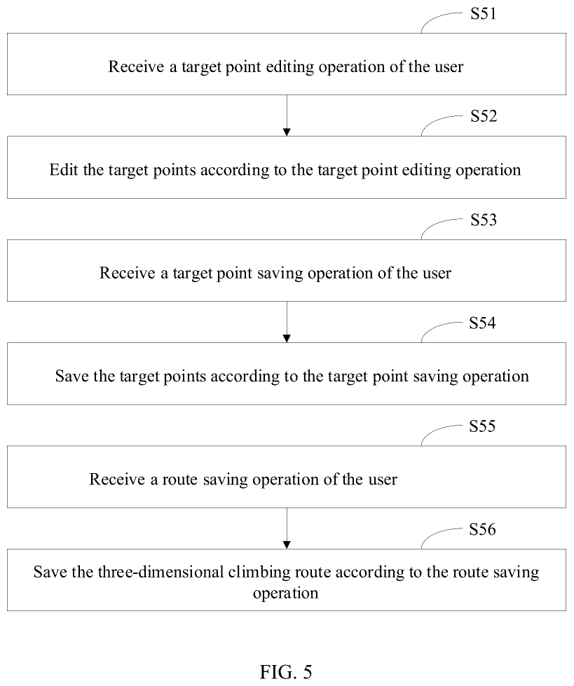

In one embodiment shown in FIG. 5, the route processing method further includes:
S51: receiving a target point editing operation of the user; and
S52: editing the target point according to the target point editing operation.

Alternatively or additionally, the route processing method further includes:
S53: receiving a target point saving operation of the user; and
S54: saving the target point according to the target point saving operation.

Alternatively or additionally, the route processing method further includes:
S55: receiving a route saving operation of the user; and
S56: saving the three-dimensional climbing route according to the route saving operation.

In one embodiment, the data information of the three-dimensional climbing route and the target point may be stored on the mobile phone APP, and different editing interfaces may be provided to meet the needs of different users. To facilitate the storage and query of route data, it may be necessary to design a data structure for storing route data. A database or local storage may be adopted. For example, in one embodiment, an SQLite database may be used to store the route data or define a route table, and the route name, start point, end point, waypoint, transportation method and other fields of the route may be specified. In the APP, the target point editing interface may be implemented, and the functions of adding, deleting, moving, and editing the target point may be implemented through UI components. For example, ListView or RecyclerView components may be used to display a target point list, Button or ImageButton components may be used to add or delete the target point, and EditText or TextView components may be used to edit target point information. The target point and route saving function may be realized by calling the interface for storing route data. For example, the operations of inserting, updating, and deleting route data may be realized in the SQLite database, and an interface for saving route data may be provided.

In one embodiment, the user may edit the target point in the three-dimensional climbing route, such that the user is able to better plan the route. The editing method may be implemented interactively. In the mobile phone APP, the gesture recognition API may be used to implement the editing method, such as long press, drag, zoom or other gestures. When the user long presses the screen, the target point may be added on the screen and its position information may be saved to the database. When the user drags or zooms the piton, the position of the target point may be adjusted according to the change of the gesture.

In one embodiment, when the user performs the target point selection operation by long press, single click, etc., based on the user's target point selection operation, the target point corresponding to the target point selection operation may be determined. When the user performs a target point editing operation by sliding, single click, etc., based on the target point editing operation, the position selected by the target point editing operation, such as the corresponding position at the end of sliding, the position corresponding to the point selected by single click, etc., may be determined as a candidate position. When the user performs a target point determination operation by clicking “Confirm” button, etc., the candidate position may be determined as the new position of the target point based on the target point determination operation. When the user performs a save operation of a target point or a three-dimensional climbing route by clicking or the like, the target point or the three-dimensional climbing route corresponding to the save operation of the target point or the three-dimensional climbing route may be stored based on the save operation of the target point or the three-dimensional climbing route.

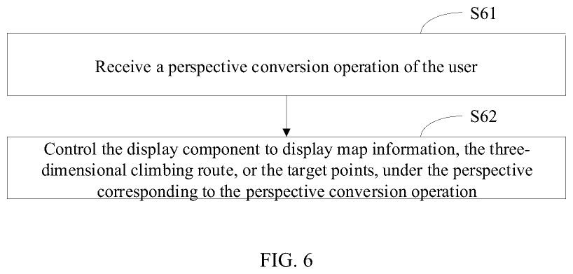

In one embodiment shown in FIG. 6, the route processing method further includes:
S61: receiving a perspective conversion operation of the user;
S62, controlling the display component to display the map information, three-dimensional climbing route or the target point at a perspective corresponding to the perspective conversion operation.

In one embodiment, when the three-dimensional climbing map and the target point are superimposed on the map information, the user may not be able to see all the target points or three-dimensional climbing route because of the perspective. To solve this problem, some interactive details may be added. For example, in one embodiment, when the user clicks on the target points, the map information perspective may automatically adjust to the best angle so that the user can see all the target points. Some zooming and rotating functions may also be added to allow the user to freely adjust the map perspective to better observe the distribution of the target points or the route. In addition, it may also be possible to consider using different colors or sizes to distinguish the importance of the target points, such that the user is able to more clearly understand the distribution of the target points on the map. When the user performs the perspective conversion operation by dragging or clicking, based on the perspective conversion operation, the display component may be controlled to display the map information, the three-dimensional climbing route or the target points at the perspective corresponding to the perspective conversion operation.

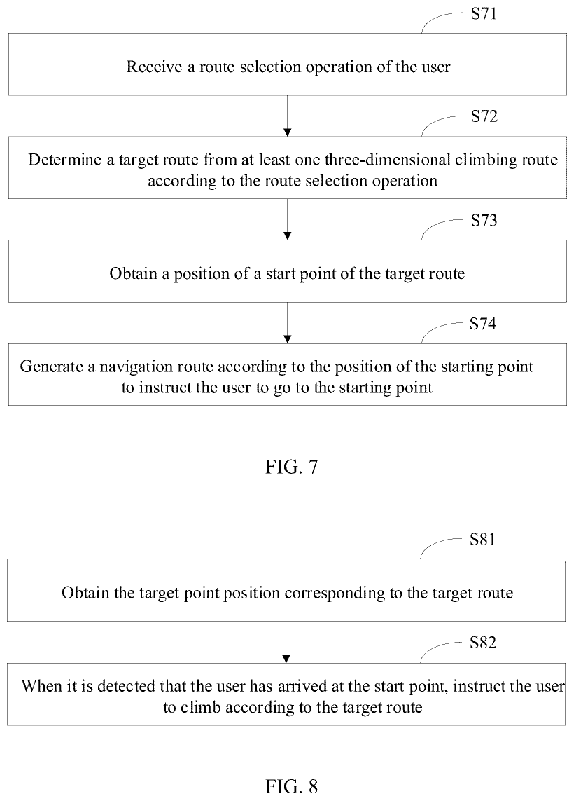

In one embodiment shown in FIG. 7, the route processing method further includes:
S71: receiving a route selection operation of the user;
S72: determining a target route from at least one three-dimensional climbing route according to the route selection operation;
S73: obtaining a location of a start point of the target route; and
S74, generating a navigation route according to the location of the start point to instruct the user to go to the start point.

In one embodiment, as shown in FIG. 8, the route processing method further includes:
S81, obtaining locations of target points corresponding to the target route; and
S82: instructing the user to climb according to the target route when it is detected that the user has arrived at the start point.

In one embodiment, the user may request to browse the three-dimensional climbing route through the mobile phone APP, and based on the user's browsing request, a route list may be displayed on the display component, including a simplified diagram of all three-dimensional climbing routes. When the user performs a route selection operation, based on the route selection operation, the target route selected by the user may be displayed on the display component, including the three-dimensional model, the three-dimensional climbing route and the target points. When a user requests navigation based on the selected target route, navigation prompts may be provided to the user based on the user's request, and the user may be navigated to the start point of the selected target route, where the start point is the start point or the first target point of the target route. When it is determined that the user has arrived at the start point, navigation prompts may be provided to the user based on the target route. During the navigation process, the GUI may prompt the user with the location and direction of one next target point. When the next target point is within the display range of the map, the next target point may be displayed. When the next target point is outside the display range of the map, an indicator may be displayed at the edge of the GUI to indicate the direction of the next target point. The direction may be determined based on the user's current first three-dimensional position and the second three-dimensional position of the target point, until the user reaches the last target point.

In the route processing method provided by the present disclosure, the user's route selection operation may be received and the target route from at least one three-dimensional climbing route may be determined according to the route selection operation. The location of the start point of the target route may be determined, and the navigation route may be determined according to the location of the start point to instruct the user to go to the start point. The need to locate the user to the start point of the climbing route may be solved.

In one embodiment, AR technology may also be integrated on the mobile phone APP end, and the three-dimensional climbing route may be projected on the rock wall or mountain by identifying the user's perspective and current position, and the rock wall or mountain effect may be achieved through the virtual scene rendering algorithm. To achieve the above functions, it may be necessary to first determine the position and direction of the rock wall or mountain to be displayed. The user's position or orientation information may be obtained through GPS or other positioning technologies, and the user's perspective may be converted into a perspective of a virtual camera in real time using the AR technology. At the same time, the three-dimensional model of the rock wall or mountain may be projected onto the camera screen to achieve virtual rendering of the rock wall or mountain. Through the virtual scene rendering algorithm, the color, texture, light and shadow or other characteristics of the rock wall or mountain may be integrated with the surrounding environment, such that the virtual rock wall or mountain is closer to the real environment, improving the user's real experience. The three-dimensional climbing route may be adjusted in real time according to the user's position and orientation to ensure that the route matches the position and direction of the rock wall or mountain to present the best visual effect. Further, the entire AR scene may be rendered to the user's mobile phone or other device. The user may control the perspective or browse the route map through the mobile device, solving the user's viewing needs of mapping the three-dimensional climbing route according to the actual rock wall or mountain on site.

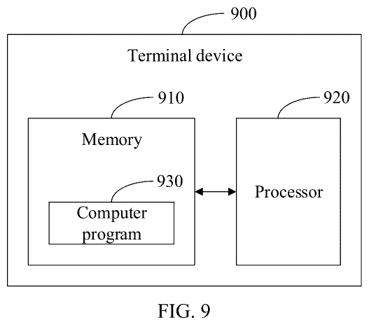

The present disclosure also provides a terminal device 900. As shown in FIG. 9, in one embodiment, the terminal device 900 includes at least one memory 910, at least one processor 920, and at least one computer program 930 stored in the at least one memory 910 and configured to be executed by the at least one processor 902. The at least one processor 920 is configured to execute the at least one computer program 930 to:
obtain a three-dimensional climbing route of a user, where the three-dimensional climbing route includes one or more first three-dimensional positions of the user during the climbing process;
determine whether a preset marking condition is satisfied;
when the marking condition is satisfied, determine a second three-dimensional position of a target point according to the one or more first three-dimensional positions;
obtain map information, where the map information includes a preset three-dimensional model;
control a display component to display the map information; and
control the display component to superimpose and display the three-dimensional climbing route and the target point on the three-dimensional model according to the one or more first three-dimensional positions and the second three-dimensional position.

In one embodiment, when the processor is configured to obtain the three-dimensional climbing route of the user, the processor may be configured to:
obtain the one or more first three-dimensional positions; and
generate the three-dimensional climbing route according to the one or more first three-dimensional positions.

In one embodiment, when the processor is configured to determine whether the preset marking condition is satisfied, the processor may be configured to:
monitor a marking operation of the user, i.e., determine whether a marking operation of the user is received;
when the marking operation is detected, i.e., when the marking operation is received, determine that the preset marking condition is satisfied.

In one embodiment, when the processor is configured to determine the second three-dimensional position of the target point according to the one or more first three-dimensional positions when the marking condition is satisfied, the processor may be configured to:
when marking operation is detected, i.e., when the marking operation is received, obtain one first three-dimensional position where the user is located when the marking operation is performed; and
determine the first three-dimensional position where the user is located when the marking operation is performed as the second three-dimensional position.

In one embodiment, when the processor executes the computer program, the processor may also be configured to:
receive a target point editing operation of the user; and
edit the target points according to the target point editing operation.

Additionally or alternatively, when the processor executes the computer program, the processor may also be configured to:
receive a target point saving operation of the user; and
save the target points according to the target point saving operation.

Additionally or alternatively, when the processor executes the computer program, the processor may also be configured to:
receive a route saving operation of the user; and
save the three-dimensional climbing route according to the route saving operation.

In one embodiment, when the processor executes the computer program, the processor may also be configured to:
receive a perspective conversion operation of the user;
control the display component to display map information, the three-dimensional climbing route, or the target points, under the perspective corresponding to the perspective conversion operation.

In one embodiment, when the processor executes the computer program, the processor may also be configured to:
receive a route selection operation of the user;
determine a target route from at least one three-dimensional climbing route according to the route selection operation;
obtain a position of a start point of the target route;
generate a navigation route according to the position of the start point to instruct the user to go to the start point.

In one embodiment, when the processor executes the computer program, the processor may also be configured to:
obtain the target point position corresponding to the target route;
when it is detected that the user has arrived at the start point, instruct the user to climb according to the target route.

In one embodiment, the terminal device may include, but is not limited to, a processor and a memory. The embodiment shown in FIG. 9 is only used as an example to illustrate the present disclosure, and does not limit the scope of the present disclosure. The terminal device may include more or fewer components than shown in the figure, or combine certain components, or different components, such as input and output devices, network access devices, etc. The input and output devices may include cameras, audio acquisition/playback devices, display screens, etc. The network access devices may include a network module for wireless network communication with external devices. In various embodiments, the processor may be a central processing unit (CPU), and may also be other general-purpose processors, digital signal processors (DSP), application-specific integrated circuits (ASIC), field-programmable gate arrays (FPGA) or other programmable logic devices, discrete gates or transistor logic devices, discrete hardware components, etc. The general-purpose processor may be a microprocessor or any conventional processor, etc.

In some embodiments, the memory may be an internal storage unit of the terminal device, such as a hard disk or memory of the terminal device. In some other embodiments, the memory may also be an external storage device of the terminal device, for example, a plug-in hard disk, a smart media card (SMC), a secure digital (SD) card, a flash card, etc. equipped on the terminal device. The memory may also include both an internal storage unit of the terminal device and an external storage device. The memory may be used to store an operating system, an application program, a boot loader, data, or other programs, such as program codes of a computer program. The memory may also be used to temporarily store data that has been output or is to be output.

The present disclosure also provides a computer readable storage medium. The computer readable storage medium may be configured to store at least one computer program. When the at least one computer program is executed by at least one processor, the route processing method provided by various embodiments of the present disclosure may be implemented.

All or part of the processes in the methods provided by various embodiments of the present disclosure may be implemented by instructing the relevant hardware through a computer program. The computer program may be stored in a computer-readable storage medium. When the computer program is executed by a processor, the steps of each of the above-mentioned method embodiments may be implemented. The computer program may include computer program codes, and the computer program codes may be in a source code form, an object code form, an executable file or some intermediate forms. The computer-readable medium may at least include: any entity or device that is able to carry the computer program codes to the terminal device, a recording medium, a computer memory, a read-only memory (ROM), a random access memory (RAM), an electrical carrier signal, a telecommunication signal, or a software distribution medium such as, for example, a USB flash drive, a mobile hard disk, a disk or an optical disk.

Each embodiment in this specification is described in a progressive manner, and each embodiment focuses on the difference from other embodiments. Reference can be made to each other for same or similar parts of the embodiments. As for the device disclosed in the embodiments, since it corresponds to the method disclosed in the embodiments, the description is relatively simple, and for relevant details, the reference may be made to the description of the method embodiments.

Devices and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the statement “comprises a . . . ” does not exclude the presence of other identical elements in an article or device that includes the above-mentioned element.

The disclosed equipment and methods may be implemented in other manners. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A route processing method comprising:
obtaining a three-dimensional climbing route of a user, the three-dimensional climbing route including one or more first three-dimensional positions of the user during climbing;
determining whether a preset marking condition is satisfied;
determining a second three-dimensional position of a target point according to the one or more first three-dimensional positions in response to the marking condition being satisfied;
obtaining map information, the map information including a preset three-dimensional model;
controlling a display component to display the map information; and
controlling the display component to superimpose and display the three-dimensional climbing route and the target point on the three-dimensional model according to the one or more first three-dimensional positions and the second three-dimensional position.

2. The method according to claim 1, wherein obtaining the three-dimensional climbing route includes:
obtaining the one or more first three-dimensional positions; and
generating the three-dimensional climbing route according to the one or more first three-dimensional positions.

3. The method according to claim 1, wherein determining whether the preset marking condition is satisfied includes:
monitoring a marking operation; and
in response to detecting the marking operation, determining that the preset marking condition is satisfied.

4. The method according to claim 1, wherein determining the second three-dimensional position in response to the marking condition being satisfied includes:
in response to detecting a marking operation, obtaining one first three-dimensional position of the one or more first three-dimensional positions that the user is located at when performing the marking operation; and
determining the one first three-dimensional position as the second three-dimensional position.

5. The method according to claim 1, further comprising:
receiving a target point editing operation; and
editing the target point according to the target point editing operation.

6. The method according to claim 1, further comprising:
receiving a target point saving operation; and
saving the target point according to the target point saving operation.

7. The method according to claim 1, further comprising:
receiving a route saving operation; and
saving the three-dimensional climbing route according to the route saving operation.

8. The method according to claim 1, further comprising:
receiving a perspective conversion operation; and
controlling the display component to display at least one of the map information, the three-dimensional climbing route, or the target point, under a perspective corresponding to the perspective conversion operation.

9. The method according to claim 1,
wherein the three-dimensional climbing route is one of at least one three-dimensional climbing route;
the method further comprising:
receiving a route selection operation;
determining a target route from the at least one three-dimensional climbing route according to the route selection operation;
obtaining a position of a start point of the target route; and
generating a navigation route according to the position of the start point.

10. The method according to claim 9, further comprising:
obtaining a target point position corresponding to the target route; and
in response to detecting that the user has arrived at the start point, providing instructions to the user to climb according to the target route.

11. A terminal device comprising:
at least one memory storing at least one computer program; and
at least one processor configured to execute the at least one computer program to:
obtain a three-dimensional climbing route of a user, the three-dimensional climbing route including one or more first three-dimensional positions of the user during climbing;
determine whether a preset marking condition is satisfied;
determine a second three-dimensional position of a target point according to the one or more first three-dimensional positions in response to the marking condition being satisfied;
obtain map information, the map information including a preset three-dimensional model;
control a display component to display the map information; and
control the display component to superimpose and display the three-dimensional climbing route and the target point on the three-dimensional model according to the one or more first three-dimensional positions and the second three-dimensional position.

12. The terminal device according to claim 11, wherein the at least one processor is further configured to execute the at least one computer program to:
obtain the one or more first three-dimensional positions; and
generate the three-dimensional climbing route according to the one or more first three-dimensional positions.

13. The terminal device according to claim 11, wherein the at least one processor is further configured to execute the at least one computer program to:
monitor a marking operation; and
in response to detecting the marking operation, determine that the preset marking condition is satisfied.

14. The terminal device according to claim 11, wherein the at least one processor is further configured to execute the at least one computer program to:
in response to detecting a marking operation, obtain one first three-dimensional position of the one or more first three-dimensional positions that the user is located at when performing the marking operation; and
determine the one first three-dimensional position as the second three-dimensional position.

15. The terminal device according to claim 11, wherein the at least one processor is further configured to execute the at least one computer program to:
receive a target point editing operation; and
edit the target point according to the target point editing operation.

16. The terminal device according to claim 11, wherein the at least one processor is further configured to execute the at least one computer program to:
receive a target point saving operation; and
save the target point according to the target point saving operation.

17. The terminal device according to claim 11, wherein the at least one processor is further configured to execute the at least one computer program to:
receive a route saving operation; and
save the three-dimensional climbing route according to the route saving operation.

18. The terminal device according to claim 11, wherein the at least one processor is further configured to execute the at least one computer program to:
receive a perspective conversion operation; and
control the display component to display at least one of the map information, the three-dimensional climbing route, or the target point, under a perspective corresponding to the perspective conversion operation.

19. The terminal device according to claim 11, wherein:
the three-dimensional climbing route is one of at least one three-dimensional climbing route; and
the at least one processor is further configured to execute the at least one computer program to:
receive a route selection operation;
determine a target route from the at least one three-dimensional climbing route according to the route selection operation;
obtain a position of a start point of the target route; and
generate a navigation route according to the position of the start point.

20. A non-transitory computer readable storage medium storing at least one computer program that, when executed by at least one processor, causes the at least one processor to:
obtain a three-dimensional climbing route of a user, the three-dimensional climbing route including one or more first three-dimensional positions of the user during climbing;
determine whether a preset marking condition is satisfied;
determine a second three-dimensional position of a target point according to the one or more first three-dimensional positions in response to the marking condition being satisfied;
obtain map information, the map information including a preset three-dimensional model;
control a display component to display the map information; and
control the display component to superimpose and display the three-dimensional climbing route and the target point on the three-dimensional model according to the one or more first three-dimensional positions and the second three-dimensional position.
